(19) United States
(12) Patent Application Publication
(10) Pub. No.: US 2017/0063784 A1
(43) Pub. Date: Mar. 2, 2017

(54) INFORMATION MANAGEMENT APPARATUS, COMMUNICATION MANAGEMENT SYSTEM, INFORMATION COMMUNICATION APPARATUS, INFORMATION MANAGEMENT METHOD, AND STORING MEDIUM STORING INFORMATION MANAGEMENT PROGRAM

(71) Applicant: NEC CORPORATION, Tokyo (JP)

(72) Inventor: Hidemi ISHIKAWA, Tokyo (JP)

(73) Assignee: NEC CORPORATION, Tokyo (JP)

(21) Appl. No.: 15/246,631

(22) Filed: Aug. 25, 2016

(30) Foreign Application Priority Data
Aug. 28, 2015 (JP) 2015-168520

(51) Int. Cl. H04L 29/12; H04L 29/06; H04L 12/26

(52) U.S. Cl. CPC H04L 61/3015; H04L 61/3025; H04L 43/04; H04L 63/205; H04L 63/1425; H04L 63/145; H04L 51/34

(57) ABSTRACT

An information management apparatus includes: a transmission-side identification information registration unit in which at least one set of transmission-side identification information each including an Internet identifier and enabling identification of a corresponding one of at least one transmission-side information communication apparatus each disposed at a transmission side of correspondence information and satisfying a predetermined condition is registered; and an information provision unit configured to provide a reception-side information communication apparatus disposed at a reception side of the correspondence information with at least one of the at least one set of transmission-side identification information, registered in the transmission-side identification information registration unit.

This application is based upon and claims the benefit of priority from Japanese Patent Application No. 2015-168520, filed on Aug. 28, 2015, the disclosure of which is incorporated herein in its entirety by reference.

### TECHNICAL FIELD

The present invention relates to an information management apparatus for managing the transmission/reception of information, a communication management system, an information communication apparatus, an information management method, and a storage medium storing an information management program therein.

### BACKGROUND ART

Correspondence information in the form of an e-mail or any other communication form (hereinafter, such correspondence information being referred to as an e-mail) is transmitted/received via communication networks, such as the Internet. Further, among such e-mails transmitted/received via communication networks, there are e-mails that harm their received sides.

In order to prevent the occurrence of damage by such a harmful e-mail, for example, the following countermeasures are taken before the content of a received e-mail is read. That is, when an e-mail is transmitted from a pre-registered transmission source (that is, when an e-mail is transmitted from a transmission source listed in a blacklist), or when it is determined through transmission-domain authentication that a received e-mail has been subjected to a so-called “spoofing” process, for example, an e-mail server having received such an e-mail discards the e-mail so as not to allow the e-mail to be transmitted a user's client terminal.

In addition, in such a countermeasure by the transmission-domain authentication, a determination as to whether or not a received-email is a harmful e-mail is made on the basis of whether or not a sender policy framework (SPF) record that coincides with the domain of the received e-mail is registered in a domain name system (DNS) server.

In PTL 1, there is disclosed a system that, in order to prevent an unauthorized access by means of “spoofing”, allows authentication using a one-time password to be made every time a server access is made.

### CITATION LIST

### Patent Literature

[PTL 1] Japanese Unexamined Patent Application Publication No. 2011-70513

### SUMMARY

Since, however, transmission sources of harmful e-mails are increased and changed every day, a situation in which a harmful e-mail transmitted from a transmission source that is not registered in the blacklist is transmitted to a user's client terminal and is read by a user is likely to frequently occur and this frequent occurrence of such a situation may further increase damages due to such harmful e-mails.

Further, in the transmission-domain authentication, a setting is sometimes made such that, when the SPF record, which coincides with the domain of a received e-mail, is not registered in the DNS server, the result of the determination is handled as “Soft Fail”, and as a result, the relevant e-mail is transmitted to a user's client terminal. For this reason, a user needs to determine whether or not every e-mail having been transmitted to his or her client terminal is harmful, and this determination on every received e-mail increases user's labor and time. Moreover, if a user fails in the determination or post-handling, this failure may lead to significant damage on the user.

It is an object of the present invention to provide an information management apparatus, a communication management system, an information communication apparatus, an information management method, and a storage medium storing an information management program therein that, upon reception of harmful correspondence information, enable appropriate handling of the harmful correspondence information.

### BRIEF DESCRIPTION OF THE DRAWINGS

Exemplary features and advantages of the present invention will become apparent from the following detailed description when taken with the accompanying drawings as below.

FIG. 1 is a block diagram illustrating an exemplary configuration of a communication management system according to a first exemplary embodiment of the present invention.

FIG. 2 is a sequence diagram illustrating the operation of an information management server in a communication management system according to a first exemplary embodiment of the present invention, when the information management server registers a set of credit information in relation to an information transmitting apparatus.

FIG. 3 is a diagram illustrating an example of sets of credit information registered in an information management DB.

FIG. 4 is a sequence diagram illustrating the operation of an information management server when the information management server changes a set of credit information registered in an information management DB.

FIG. 5 is a sequence diagram illustrating the operation of an information receiving apparatus when the information receiving apparatus receives information based on sets of credit information registered in an information management DB of an information management server.

FIG. 6 is a sequence diagram illustrating the operation of an information management server when the information management server delivers sets of delivery information on the basis of sets of credit information registered in an information management DB.

FIG. 7 is a diagram illustrating an example of sets of information registered in an information DB.

FIG. 8 is a sequence diagram illustrating the operation of an information management server when, in response to a request from the information receiving apparatus, the information management server delivers sets of credit information registered in an information management DB to the information receiving apparatus.

FIG. 9 is a diagram illustrating the operation of an information receiving apparatus when the information receiving apparatus determines whether or not a received e-mail is a harmful e-mail.

FIG. 10 is a sequence diagram illustrating the operation of an information receiving apparatus when the information receiving apparatus has determined that an e-mail having been received from an information transmitting apparatus is harmful.

FIG. 11 is a diagram illustrating an example of sets of violation information registered in an information management DB.

FIG. 12 is a sequence diagram illustrating the operation of an information management server when the information management server provides a set of notification information to an information transmitting apparatus that is a transmission source of a harmful e-mail.

FIG. 13 is a block diagram illustrating an exemplary configuration of an information management apparatus according to a second exemplary embodiment of the present invention.

FIG. 14 is a block diagram illustrating an exemplary configuration of an information communication apparatus according to a third exemplary embodiment of the present invention.

### EXEMPLARY EMBODIMENT

Next, a detailed explanation will be given for exemplary embodiments with reference to the drawings.

### First Exemplary Embodiment

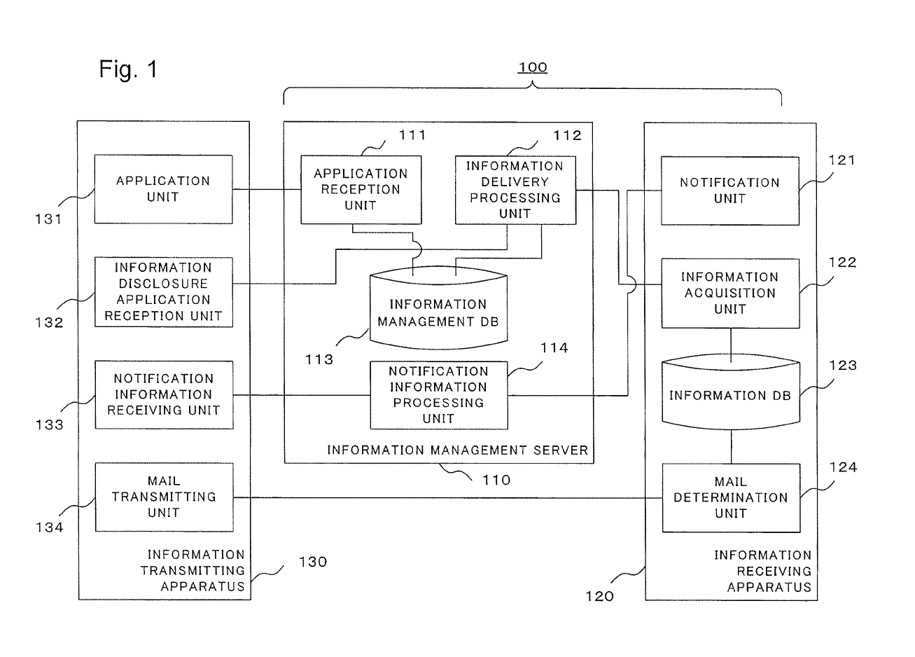

A communication management system 100 according to a first exemplary embodiment of the present invention, will be described with reference to the drawings. FIG. 1 is block diagram illustrating an exemplary configuration of the communication management system 100 according to the first exemplary embodiment of the present invention. As shown in FIG. 1, the communication management system 100 according to the first exemplary embodiment of the present invention, includes an information management server 110 and an information receiving apparatus 120. Further, the information management server 110 and the information receiving apparatus 120 are coupled to a communication network (not illustrated), such as the Internet. Further, an information transmitting apparatus 130 is coupled to the communication network. Accordingly, the information management server 110, the information receiving apparatus 120, and the information transmitting apparatus 130 transmit/receive information to/from one another via the communication network. Further, the information receiving apparatus 120 determines whether or not an e-email having been transmitted by the information transmitting apparatus 130 and having been received by the information receiving apparatus 120 itself is an e-mail having low reliability, that is, an e-mail having a low harmlessness degree (hereinafter, this kind of e-mail being referred to as just a harmful e-mail), on the basis of information having been registered into the information management server 110 by the information transmitting apparatus 130. The communication management system 100 may include the information transmitting apparatus 130.

In addition, the information management server 110, the information receiving apparatus 120, and the information transmitting apparatus 130 are each realized by, for example, a computer in which a central processing unit (CPU), which executes processing in accordance with program control, is mounted. Further, each of the information receiving apparatus 120 and the information transmitting apparatus 130 corresponds to, for example, a mail server, and a single client terminal or a plurality of client terminals (not illustrated) is or are coupled to each of the information receiving apparatus 120 and the information transmitting apparatus 130. In addition, each of the information receiving apparatus 120 and the information transmitting apparatus 130 is introduced and operated by one of various organizations. Non-limiting examples of such organizations include an enterprise, a public office, and an educational institution and a research institution of an educational organization, such as a university.

As shown in FIG. 1, the information management server 110 includes an application reception unit 111, an information delivery processing unit 112, an information management database (DB) 113, and a notification information processing unit 114.

The application reception unit 111 receives a registration application for registering a set of credit information, from the information transmitting apparatus 130. It should be noted that the set of credit information is, for example, a set of information that enables identification of an operator of the information transmitting apparatus 130. The details of this set of credit information will be described later. The information delivery processing unit 112 delivers information in accordance with sets of credit information registered in the information management DB 113. The sets of credit information are registered in the information management DB 113. The notification information processing unit 114 receives a set of notification information including information to be notified to the information transmitting apparatus 130, and performs processing in accordance with the received set of notification information.

It should be noted that the application reception unit 111, the information delivery processing unit 112, and the notification information processing unit 114 are, for example, each realized by a single circuit including a CPU, which executes processing in accordance with program control, a communication module, and any other component, or a plurality of circuits each including a CPU, a communication module, and any other component. The information management DB 113 is, for example, realized by a storage means, such as a memory module or a hard disk.

As shown in FIG. 1, the information receiving apparatus 120 includes a notification unit 121, an information acquisition unit 122, an information DB 123, and a mail determination unit 124.

The notification unit 121 transmits a set of notification information, described below. The information acquisition unit 122 acquires information in accordance with sets of credit information from the information management server, and registers the acquired information into an information DB 123. The information DB 123 stores the registered set of information therein. The mail determination unit 124 determines whether or not a received e-mail is a harmful e-mail.

As shown in FIG. 1, the information transmitting apparatus 130 includes an application unit 131, an information disclosure application reception unit 132, a notification information receiving unit 133, and a mail transmitting unit 134.

The application unit 131 transmits a set of registration application information for applying a registration of a set of credit information, to the information management server 110. The information disclosure application reception unit 132 receives a disclosure applications for applying a disclosure of a set of credit information. The notification information receiving unit 133 receives a set of notification information described below. The mail transmitting unit 134 transmits an e-mail.

It should be noted that the information transmitting apparatus 130 and the information receiving apparatus 120 may include elements equivalent to each other. Specifically, the information transmitting apparatus 130 may include elements equivalent to the notification unit 121, the information acquisition unit 122, the information DB 123, and the mail determination unit 124, and the information receiving apparatus 120 may include elements equivalent to the application unit 131, the information disclosure application reception unit 132, the notification information receiving unit 133, and the mail transmitting unit 134.

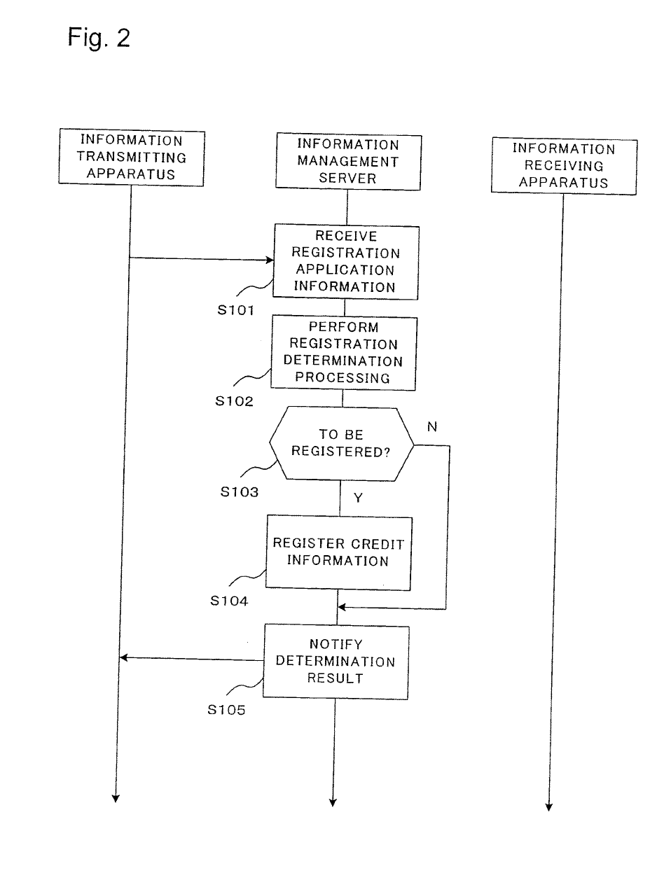

Next, the operation of the communication management system 100 according to the first exemplary embodiment of the present invention, will be described. FIG. 2 is a sequence diagram illustrating the operation of the information management server 110 in the communication management system 100 according to the first exemplary embodiment of the present invention, when the information management server 110 registers a set of credit information in relation to the information transmitting apparatus 130.

As shown in FIG. 2, the information management server 110 (specifically, the application reception unit 111) receives a set of registration application information having been transmitted by the information transmitting apparatus 130 (specifically, the application unit 131) (step S101). Here, it is supposed that the set of registration application information includes a set of credit information indicating, for example, a user name corresponding to the operator of the information transmitting apparatus 130; an Internet identifier, zone information, or address resource information corresponding to the information transmitting apparatus 130; and whether the registration application information is permitted to be disclosed or not.

It should be noted that the Internet identifier corresponds to, for example, an Internet protocol (IP) address and a domain name. Further, the zone information corresponds to, for example, information indicating the authority range of a domain name. The address resource information corresponds to information indicating, for example, an IP address, a domain name, or a protocol number. In this embodiment, it is supposed that the set of registration application information includes information indicating the IP address and the domain name, which serve as the Internet identifier of the information transmitting apparatus 130. It should be noted that the operator of the information receiving apparatus 120 and the operator of the information transmitting apparatus 130 correspond to an organization that operates the information receiving apparatus 120 and an organization that operates the information transmitting apparatus 130. Non-limiting examples of the organization include an enterprise, a public office, and an educational institution and a research institution of an educational organization, such as a university.

The application reception unit 111 performs registration determination processing for determining whether or not a set of credit information included in the set of registration application information, having been received in the processing in step S101, is to be registered into the information management DB 113, on the basis of the relevant set of registration application information (step S102).

Here, the registration determination processing will be described. For example, the application reception unit 111 performs confirmation on an IP address and a domain indicated by information included in the set of registration application information by means of forward lookup and reverse lookup using DNS commands. Further, the application reception unit 111 determines whether or not the set of credit information included in the set of registration application information is to be registered, on the basis of whether or not the IP address and the domain, indicated by the information included in the set of registration application information, coincide with DNS setting information in relation to an operator operating the information transmitting apparatus 130 and indicated by the set of registration application information. Further, the application reception unit 111 acquires, for example, information in relation to a rating score possessed by a credit investigation agency as part of a credit investigation on the operator operating the information transmitting apparatus 130 and indicated by the set of registration application information. Further, in the case where the operator operating the information transmitting apparatus 130 and indicated by the set of registration application information is, for example, an enterprise having a rating score larger than or equal to 66 points, the application reception unit 111 determines that the set of credit information included in the relevant set of registration application information is to be registered. It should be noted that the registration determination processing may be performed manually. Further, a user having been determined to be registered through the registration determination processing corresponds to a user that satisfies a predetermined condition.

When having determined the execution of the registration, through the registration determination processing in step S102 (“Y” in step S103), the application reception unit 111 registers the set of credit information, included in the set of registration application information having been received in the processing in step S101, into the information management DB 113 (step S104), and then, causes the process flow to proceed to processing in step S105.

In contrast, when having determined the non-execution of the registration, through the registration determination processing in step S102 (“N” in step S103), the application reception unit 111 causes the process flow to proceed to processing in step S105.

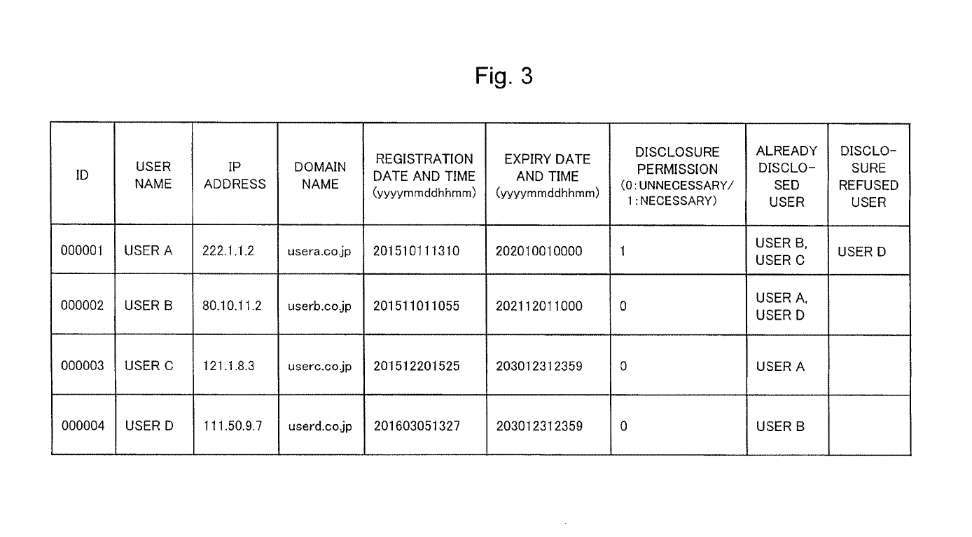

FIG. 3 is a diagram illustrating an example of sets of credit information registered in the information management DB 113. In the example shown in FIG. 3, although the sets of credit information are registered in the information management DB 113 in a tabular form, the sets of credit information may be registered in a comma separated values (CSV) form.

Further, in the example shown in FIG. 3, a first set of credit information among the sets of credit information registered in the information management DB 113 indicates that “ID” of the relevant set of credit information is “000001”; “user name” is “user A”; “IP address” is “222.1.1.2; “domain name” is “usera.co.jp”; “registered date and time” is “201510111310”; “expiry date and time” of the relevant set of credit information is “202010010000”; and “disclosure permission application” is “necessary”. It should be noted that the “ID”, “registered date and time”, and “expiry date and time” in the set of credit information are set and registered by, for example, the information management server 110 (specifically, the application reception unit 111). Further, the “user name”, “IP address”, and “domain name” are registered on the basis of the set of registration application information. It should be noted that pieces of information registered in a field “already disclosed user” and a field “disclosure refused user” will be described below.

In the example shown in FIG. 3, a second set of credit information among the sets of credit information registered in the information management DB 113 indicates that “ID” of the relevant set of credit information is “000002”; “user name” is “user B”; and “IP address” is “80.10.11.2”; “domain name” is “userb.co.jp”; “registered date and time” is “201511011055”; “expiry date and time” of the relevant set of credit information is “202112011000”; and “disclosure permission application” is unnecessary.

Further, in the example shown in FIG. 3, a third set of credit information among the sets of credit information registered in the information management DB 113 indicates that “ID” of the relevant set of credit information is “000003”; “user name” is “user C”; “IP address” is “121.1.8.3”; “domain name” is “userc.co.jp”; “registered date and time” is “201512201525”; “expiry date and time” of the relevant set of credit information is “203012312359”; and “disclosure permission application” is unnecessary.

In the example shown in FIG. 3, a fourth set of credit information among the sets of credit information registered in the information management DB 113 indicates that “ID” of the relevant set of credit information is “000004”; “user name” is “user D”; “IP address” is “111.50.9.7”; “domain name” is “userd.co.jp”; “registered date and time” is “201603051327”; “expiry date and time” of the relevant set of credit information is “203012312359”; and “disclosure permission application” is unnecessary.

In the processing in step S105, the application reception unit 111 notifies the information transmitting apparatus 130 (specifically, the application unit 131) of a result of the determination having been made in the registration determination processing (step S105).

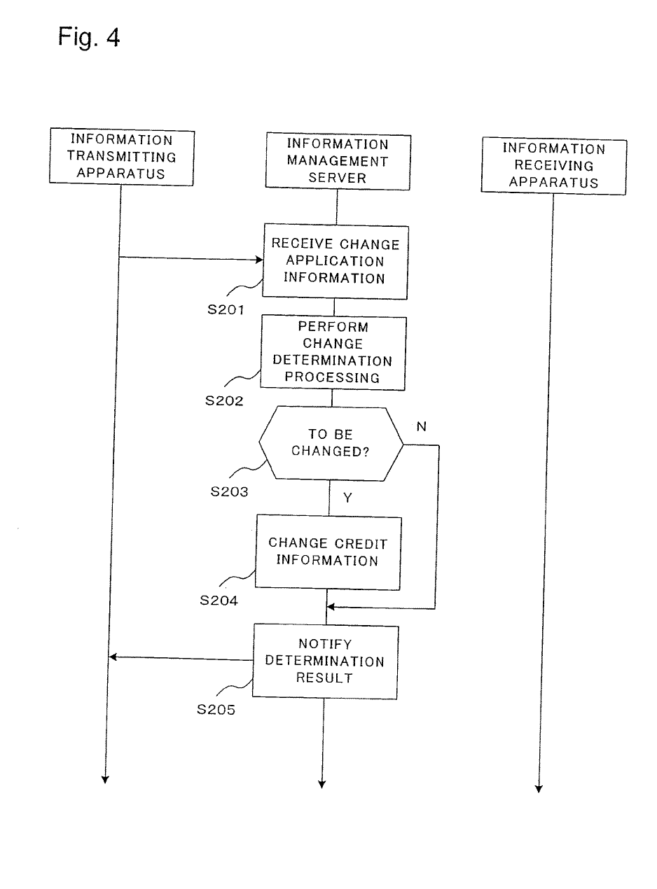

Next, the operation of the information management server 110 when the information management server 110 changes a set of credit information registered in the information management DB 113 will be described. FIG. 4 is a sequence diagram illustrating the operation of the information management server 110 when the information management server 110 changes a set of credit information registered in the information management DB 113.

As shown in FIG. 4, the information management server 110 (specifically, the application reception unit 111) receives a set of change application information having been transmitted by the information transmitting apparatus 130 (specifically, the application unit 131) (step S201). Here, it is supposed that the set of change application information includes, for example, information indicating registered content desired to be changed and content after the change.

The application reception unit 111 performs change determination processing for determining whether or not a relevant set of credit information registered in the information management DB 113 is to be changed, on the basis of the set of change application information, having been received in the processing in step S201 (step S202).

When having determined the execution of the change, through the change determination processing in step S202 (“Y” in step S203), the application reception unit 111 changes the content of the relevant set of credit information, registered in the information management DB 113, on the basis of the set of change application information, having been received in the processing in step S201 (step S204), and then, causes the process flow to proceed to processing in step S205.

In contrast, when having determined the non-execution of the change, through the change determination processing in step S202 (“N” in step S203), the application reception unit 111 causes the process flow to proceed to processing in step S205.

In the processing in step S205, the application reception unit 111 notifies the information transmitting apparatus 130 (specifically, the application unit 131) of a result of the determination having been made in the change determination processing (step S205).

Here, for example, when the deletion of part or the whole of a relevant set of credit information is indicated by the set of change application information, the information management server 110 (specifically, the application reception unit 111) deletes corresponding registered content in the information management DB 113 in the processing in step S204. It should be noted that a fact that the deletion of part or the whole of a relevant set of credit information is indicated by the set of change application information corresponds to a fact that a predetermined condition needed to delete part or the whole of the relevant set of credit information has been satisfied.

Further, in the change determination processing in step S202, a determination as to whether or not the change or the deletion is to be performed is made on the basis of, for example, a criterion similar to that in the registration determination processing in step S102 shown in FIG. 1.

Next, the operation of the information receiving apparatus 120 when the information receiving apparatus 120 receives information based on sets of credit information registered in the information management DB 113 of the information management server 110 will be described.

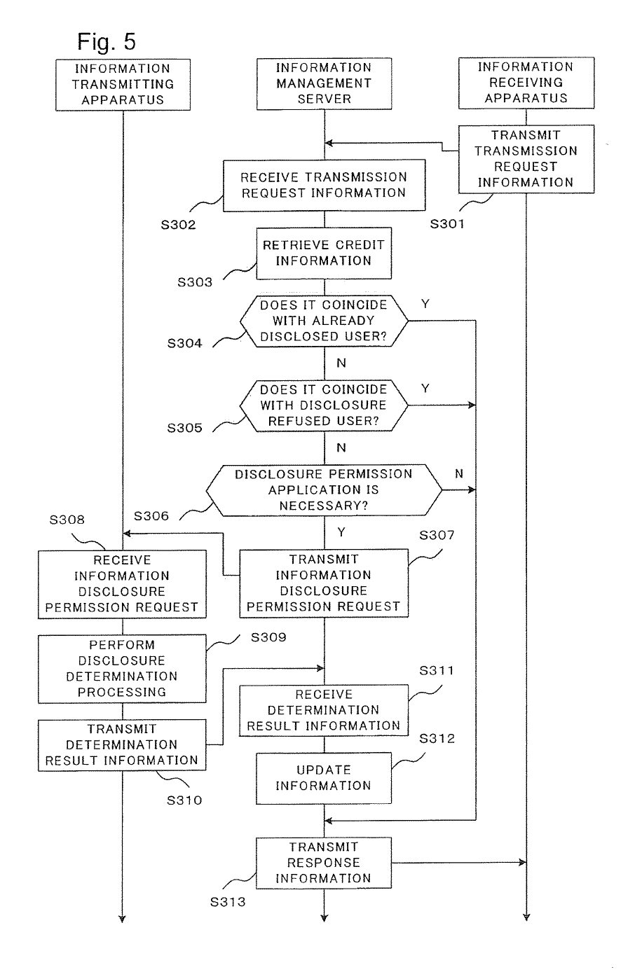

FIG. 5 is a sequence diagram illustrating the operation of the information receiving apparatus 120 when the information receiving apparatus 120 receives information based on sets of credit information registered in the information management DB 113 of the information management server 110. As shown in FIG. 5, the information receiving apparatus 120 (specifically, the information acquisition unit 122) transmits a set of transmission request information indicating a request for transmission of a registered set of credit information, to the information management server 110 (step S301). Here, it is supposed that the set of transmission request information includes information indicating, for example, the operator of the information receiving apparatus 120, and the operator and the domain of an information transmitting apparatus 130, the transmission source of an e-mail the operator of the information receiving apparatus 120 desires to receive.

The information management server 110 (specifically, the information delivery processing unit 112) receives the set of transmission request information, having been transmitted in the processing in step S301 (step S302). Further, the information delivery processing unit 112 retrieves a set of credit information registered in the information management DB 113 on the basis of the set of transmission request information, having been received in the processing in step S302 (step S303). Specifically, the information delivery processing unit 112 retrieves a set of credit information included in the sets of credit information registered in the information management DB 113 and including a user name and a domain name that coincide with the operator and the domain that are indicated by the information included in the received set of transmission request information and that are associated with an information transmitting apparatus 130, the transmission source of an e-mail the operator of the information receiving apparatus 120 desires to receive.

Further, in the case where any one of at least one already-disclosed user included in the set of credit information having been retrieved in the processing in step S303 coincides with the operator operating the information receiving apparatus 120, the transmission source of the relevant set of transmission request information, and indicated by the information included in the set of transmission request information (“Y” in step S304), the information delivery processing unit 112 causes the process flow to proceed to processing in step S313.

Further, in the case where any one of at least one disclosure-refused user included in the set of credit information having been retrieved in the processing in step S303 coincides with the operator operating the information receiving apparatus 120, the transmission source of the relevant set of transmission request information, and indicated by the information included in the set of transmission request information (“Y” in step S305), the information delivery processing unit 112 causes the process flow to proceed to processing step S313.

In the case where, in the set of credit information having been retrieved in the processing in step S303, it is indicated that the disclosure permission application is necessary (“Y” in step S306), the information delivery processing unit 112 causes the process flow to proceed to processing in step S307; otherwise (“N” in step S306), the information delivery processing unit 112 causes the process flow to proceed to processing in step S313.

In the processing in step S307, the information delivery processing unit 112 transmits an information disclosure permission request for requesting the disclosure of the relevant set of credit information, to the information transmitting apparatus 130 (step S307). Here, it is supposed that the information disclosure permission request includes, for example, a set of transmission source information indicating the operator of the information receiving apparatus 120, the transmission source of the set of transmission request information.

The information transmitting apparatus 130 (specifically, the information disclosure application reception unit 132) receives the information disclosure permission request, having been transmitted by the information management server 110 (specifically, the information delivery processing unit 112) in the processing in step S307 (step S308). Further, the information disclosure application reception unit 132 performs disclosure determination processing for determining whether or not the relevant set of credit information is to be disclosed to the operator operating the information receiving apparatus 120 and indicated by the set of transmission source information included in the information disclosure permission request (step S309).

It should be noted that the disclosure determination processing may be performed, for example, manually or by means of a method that allows the execution of the disclosure of the relevant set of credit information to be determined in the case where any one of operators operating information receiving apparatuses 120 and registered in advance in a list of disclosure permission destinations coincides with the operator operating the information receiving apparatus 120 and indicated by the set of transmission source information. Here, for example, trading partners, and the like, for the operators of the information transmitting apparatus 130 are registered to the list of disclosure permission destinations.

Further, the information disclosure application reception unit 132 transmits a piece of determination result information indicating a result of the determination by the disclosure determination processing in step S309 to the information management server 110 (step S310)

The information management server 110 (specifically, the information delivery processing unit 112) receives the piece of determination result information, having been transmitted in the processing in step S310 (step S311). Further, in accordance with the piece of determination result information, having been received in the processing in step S311, the information delivery processing unit 112 updates information registered in the information management DB 113 (step S312).

Specifically, in the case where the piece of determination result information indicates the execution of the disclosure of the relevant set of credit information to the operator of the information receiving apparatus 120, for example, the information delivery processing unit 112 registers, in the information management DB 113, the operator of the information receiving apparatus 120 (corresponding to “user B” in the example shown in FIG. 3) into a field “already disclosed user” associated with the relevant set of credit information, in which “user name” is the operator of the information transmitting apparatus 130 (corresponding to “user A” in the example shown in FIG. 3).

Further, in the case where the piece of determination result information indicates the non-execution of the disclosure of the relevant set of credit information to the operator of the information receiving apparatus 120, for example in the information management DB 113, the information delivery processing unit 112 registers the operator of the information receiving apparatus 120 (corresponding to “user D” in the example shown in FIG. 3) into a field “disclosure refused user” associated with the relevant set of credit information, in which “user name” is the operator of the information transmitting apparatus 130 (corresponding to “user A” in the example shown in FIG. 3).

Further, the information delivery processing unit 112 transmits a set of response information in accordance with the piece of determination result information, having been received in the processing in step S311, to the information receiving apparatus 120 (step S313).

In addition, in the processing in step S313, five kinds of sets of response information are transmitted to the information receiving apparatus 120 by the information delivery processing unit 112 on the basis of respective determination results: a first one being information that is transmitted when a corresponding piece of determination result information has indicated the execution of the disclosure of the relevant set of credit information to the operator of the information receiving apparatus 120, and that indicates, for example, the determination result; a second one being information that is transmitted when a corresponding piece of determination result information has indicated the non-execution of the disclosure of the relevant set of credit information to the operator of the information receiving apparatus 120, and that indicates, for example, the determination result; a third one being information transmitted when the result of the determination in the processing in step S304 has been “Y”, and indicating, for example, the result of the determination; a fourth one being information transmitted when the result of the determination in the processing in step S305 has been “Y”, and indicating, for example, the determination result; a fifth one being information transmitted when the result of the determination in the processing in step S306 has been “N”, and indicating, for example, the determination result.

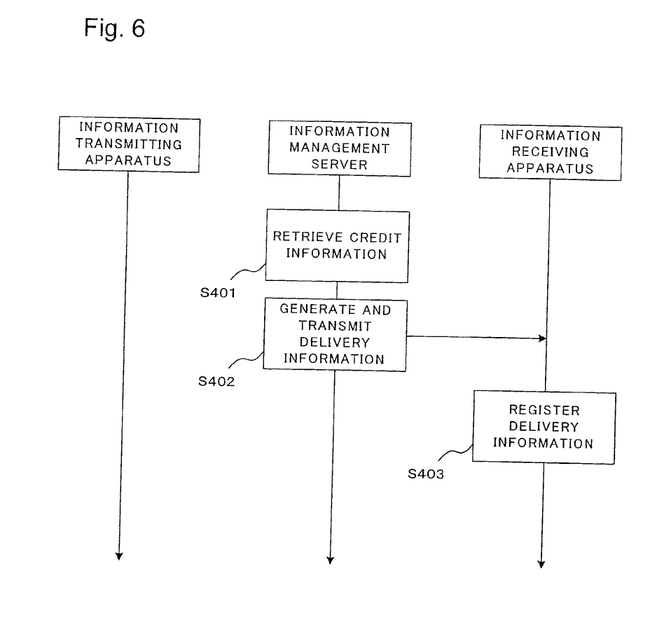

The operation of the information management server 110 when the information management server 110 delivers at least one set of delivery information on the basis of the sets of credit information registered in the information management DB 113 will be described below. FIG. 6 is a sequence diagram illustrating the operation of the information management server 110 when the information management server 110 delivers at least one set of delivery information on the basis of the sets of credit information registered in the information management DB 113.

As shown in the FIG. 6, the information management server 110 (specifically, the information delivery processing unit 112) retrieves at least one set of credit information from the information management DB 113 (step S401). Here, in the processing in step S401, the information delivery processing unit 112 retrieves at least one set of credit information in each of which, for example, “disclosure permission application” is “unnecessary” or the operator of the information receiving apparatus 120, which is the transmission destination of the relevant set of delivery information, is set in the field “already disclosed user”, from among the sets of credit information registered in the information management DB 113.

Further, the information delivery processing unit 112 generates a set of delivery information on the basis of the at least one set of credit information having been retrieved in the processing in step S401, and transmits the generated set of delivery information to the information receiving apparatus 120 (step S402). Here, the set of delivery information is information indicating, for example, “ID”, “user name”, “IP address”, “domain name”, and “expiry date and time” in each of the at least one set of credit information having been retrieved in the processing in step S401. It should be noted that any one of “ID” and “user name” or both of “ID” and “user name” in each of the at least one set of credit information may not be included in the set of delivery information.

The timing at which the information management server 110 performs the processing in steps S401 and S402 may correspond to each of predetermined time intervals of a period of time equivalent to once a day, a plurality of times a day, once per several days, or any other interval. Further, the timing may correspond to a timing point in response to a request from the information receiving apparatus 120 or a request from the information transmitting apparatus 130, or a timing point in response to a request from the operator of the information management server 110.

The information receiving apparatus 120 (specifically, the information acquisition unit 132) receives the set of delivery information, having been transmitted in the processing in step S402, and registers it into the information DB 123 (step S403).

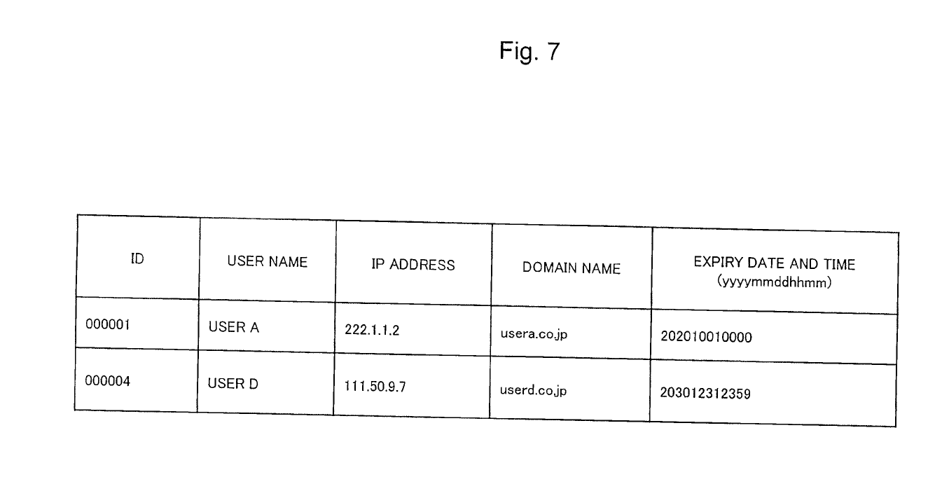

FIG. 7 is a diagram illustrating an example of sets of information registered in the information DB 123. In the example shown in FIG. 7, a first set of information among the sets of information registered in the information DB 123 indicates that “ID” of a corresponding set of credit information is “00001”; “user name” is “user A”; “IP address” is “222.1.1.2”; “domain name” is “usera.co.jp”; and “expiry date and time” of the corresponding set of credit information is “202010010000”. Further, in the example shown in FIG. 7, a second set of information among the sets of information registered in the information DB 123 indicates that “ID” of a corresponding set of credit information is “00004”; “user name” is “user D”; “IP address” is “111.50.9.7”; “domain name” is “userd.co.jp”; “expiry date and time” of the corresponding set of credit information is “203012312359”.

In the example shown in FIG. 7, in each of the sets of information registered in the information DB 123, an ID included in a corresponding set of credit information registered in the information management DB 123 is registered. Accordingly, in a case where the correspondence relationship between registered content of the information DB 123 and registered content of the information management DB 113 is investigated, or in any other similar case, not only time and labor consumed in searching, but also processing load on the searching, is reduced.

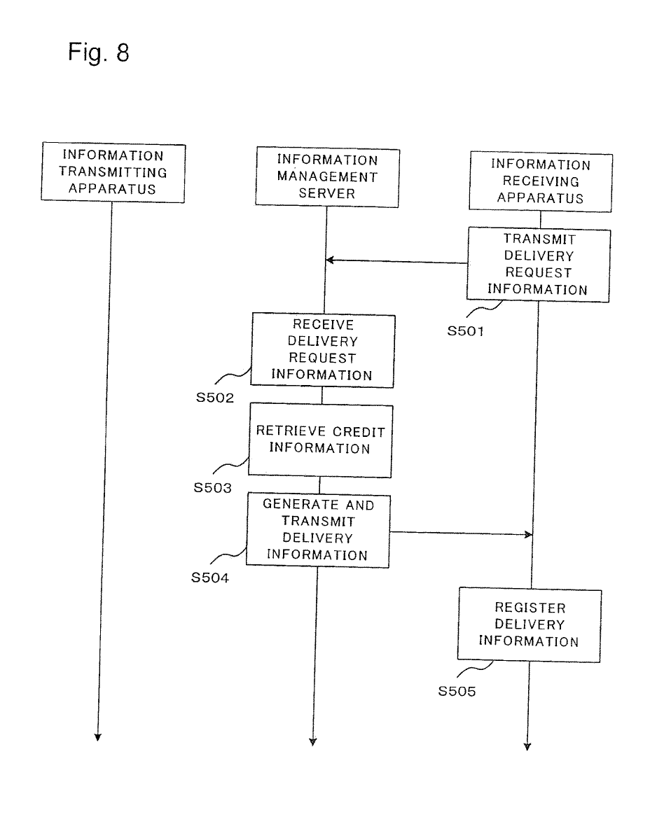

FIG. 8 is a sequence diagram illustrating the operation of the information management server 110 when, in response to a request from the information receiving apparatus 120, the information management server 110 delivers at least one set of credit information among the sets of credit information registered in the information management DB 113 to the information receiving apparatus 120.

As shown in FIG. 8, the information receiving apparatus 120 (specifically, the information acquisition unit 122) transmits a set of delivery request information for requesting the transmission of at least one set of delivery information, to the information management server 110 (step S501). Here, it is supposed that the set of delivery request information includes information indicating, for example, the operator of the information receiving apparatus 120, and the operator of each of at least one information transmitting apparatus 130 in accordance with a set of delivery information requested to be transmitted.

Further, the information management server 110 (specifically, the information delivery processing unit 112) receives the set of delivery request information, having been transmitted in the processing in step S501 (step S502). Further, the information delivery processing unit 112 retrieves at least one set of credit information from the information management DB 113 (step S503). Here, in the processing in step S503, the information delivery processing unit 112 retrieves at least one credit information in each of which, for example, “disclosure permission application” is “unnecessary”, or “already disclosed user” is the operator of the information receiving apparatus 120, which is the transmission destination of the relevant set of delivery request information, from among the sets of credit information registered in the information management DB 113.

The information delivery processing unit 112 generates a set of delivery information on the basis of the at least one set of credit information having been retrieved in the processing in step S503, and transmits the generated set of delivery information to the information receiving apparatus 120 (step S504).

The information receiving apparatus 120 (specifically, the information acquisition unit 132) receives the set of delivery information, having been transmitted in the processing in step S504, and registers it into the information DB 123 (step S505).

It should be noted that in the processing shown in FIG. 6 or the processing shown in FIG. 8, the information delivery processing unit 112 may transmit information including differences with delivery information having been transmitted by the last time transmission; information including only the differences; information to which information indicating the differences is attached; or any other similar information, as a set of delivery information to be transmitted this time.

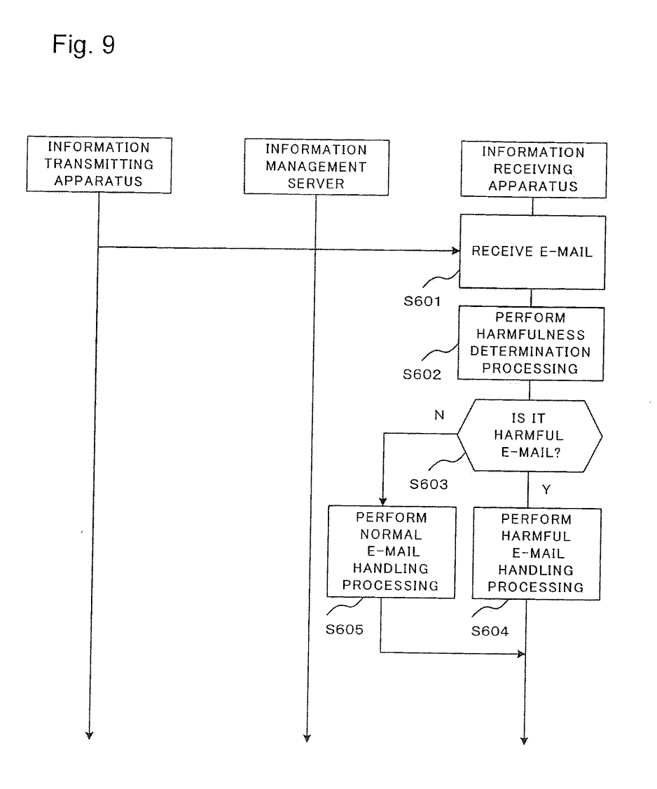

Next, the operation of the information receiving apparatus 120 when the information receiving apparatus 120 determines whether or not a received e-mail is a harmful e-mail will be described below. FIG. 9 is a diagram illustrating the operation of the information receiving apparatus 120 when the information receiving apparatus 120 determines whether or not a received e-mail is a harmful e-mail.

As shown in FIG. 9, the information receiving apparatus 120 (specifically, the mail determination unit 124) receives an e-mail having been transmitted by the information transmitting apparatus 130 (specifically, the mail transmitting unit 134) (step S601).

The mail determination unit 124 performs harmfulness determination processing for determining whether or not the e-mail, having been received in the processing in step S601, is a harmful e-mail (step S602).

Specifically, the mail determination unit 124 determines whether or not a domain and an IP address of a transmission source, the domain and the IP being included in a header portion of the e-mail having been received in the processing in step S601, are registered in the information DB 123, and then, determines whether or not the e-mail is a harmful e-mail, in accordance with the result of the above determination.

Further, when having determined in the harmfulness determination processing in step S602 that the e-mail, having been received in the processing in step S601, is a harmful e-mail (“Y” in step S603), the mail determination unit 124 performs harmful e-mail handling processing (step S604).

Specifically, in the harmful e-mail handling processing, for example, the mail determination unit 124 discards the e-mail, having been received in the processing in step S601, and transmits an e-mail for notifying a refusal response, to the transmission source of the e-mail. Further, in the harmful e-mail handling processing, for example, the mail determination unit 124 inserts a word “Fishing” into the title of the e-mail, and/or inserts a word “X-Trust: Fishing” in the header portion of the e-mail, and then, transmits the e-mail having been subjected to such an insertion process to a client terminal that is the transmission destination of the e-mail.

Further, when having determined in the harmfulness determination processing in step S602 that the e-mail, having been received in the processing in step S601, is not a harmful e-mail (“N” in step S603), the mail determination unit 124 performs normal e-mail handling processing (step S605).

Specifically, in the normal e-mail handling processing, for example, the mail determination unit 124 inserts a word “trust” into the title of the e-mail, and/or inserts a word “X-Trust: Trust” in the header portion of the e-mail, and then, transmits the e-mail having been subjected to such an insertion process to a client terminal that is the transmission destination of the e-mail.

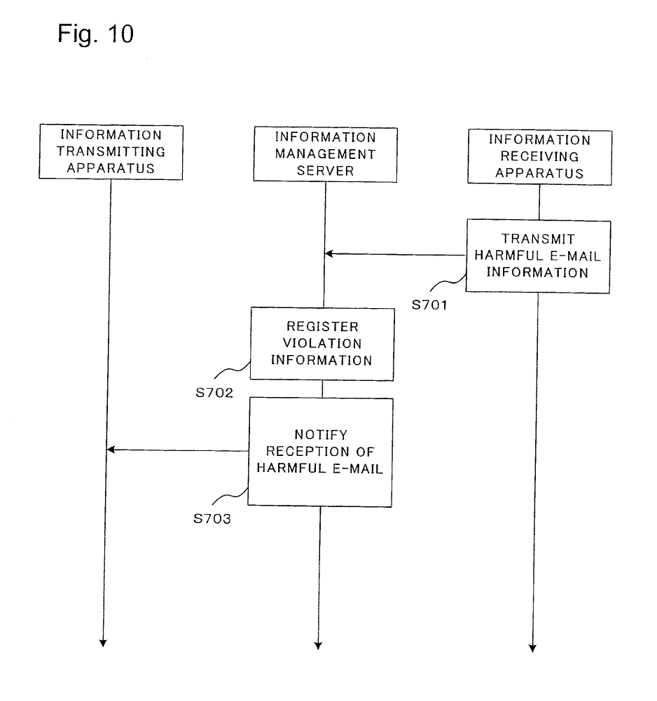

Next, the operation of the information receiving apparatus 120 when the information receiving apparatus 120 has determined that the e-mail having been received from the information transmitting apparatus 130 is harmful will be described below. FIG. 10 is a sequence diagram illustrating the operation of the information receiving apparatus 120 when the information receiving apparatus 120 has determined that the e-mail having been received from the information transmitting apparatus 130 is harmful. As shown in FIG. 10, when having received a harmful e-mail from the information transmitting apparatus 130, the information receiving apparatus 120 (specifically, the notification unit 121) transmits a set of harmful e-mail information in relation to the harmful e-mail to the information management server 110 (step S701). It should be noted that the set of harmful e-mail information includes, for example, an e-mail address of the transmission source of the harmful e-mail; an IP address, a domain, and any other information associated with the transmission source and included in the header portion of the harmful e-mail; the content of the harmfulness; the operator of the information receiving apparatus 120, the transmission source of the set of harmful e-mail information, and the relevant harmful e-mail is attached to the set of harmful e-mail information. In this embodiment, it is supposed that the set of harmful e-mail information includes the IP address and the domain of the information transmitting apparatus 130 and information indicating that the received e-mail is an e-mail infected with a virus. It should be noted that information indicating the content of harmfulness is created by the operator of the information receiving apparatus 120, and is attached to the set of harmful e-mail information.

The information management server 110 (specifically, the notification information processing unit 114) receives the set of harmful e-mail information, having been transmitted in the processing in step S701, and registers a set of violation information based on the received set of harmful e-mail information into the information management DB 113 (step S702).

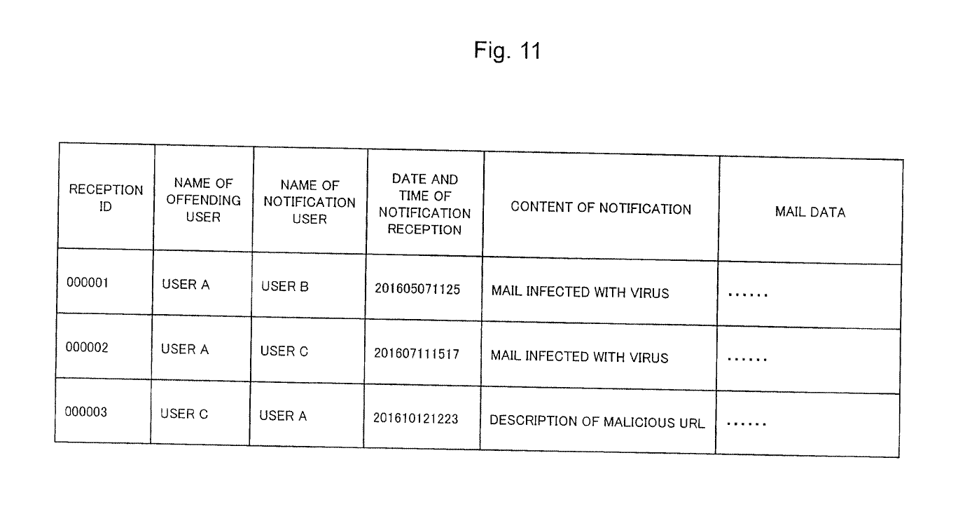

FIG. 11 is a diagram illustrating an example of sets of violation information registered in the information management DB 113. As shown in FIG. 11, a set of violation information indicating that “reception ID” is “000001”; “name of offending user” is “user A”; “name of notification user” is “user B”; “date and time of notification reception” is “201605071125”; and “content of notification” is “e-mail infected with virus” is registered in the information management DB 113, and a corresponding harmful e-mail is attached to this set of violation information.

Further, a set of violation information indicating that “reception ID is “000002”; “name of offending user is “user A”; “name of notification user” is “user C”; “date and time of notification reception” is “201607111517”; and “content of notification” is “e-mail infected with virus” is registered in the information management DB 113, and a corresponding harmful e-mail is attached to this set of violation information.

A set of violation information indicating that “reception ID is “000003”; “name of offending user is “user C”; “name of notification user” is “user A”; “date and time of notification reception” is “201610121223”; and “content of notification” is “description of malicious URL (Uniform Resource Locator)” is registered in the information management DB 113, and a corresponding harmful e-mail is attached to this set of violation information.

Here, for example, the notification information processing unit 114 registers a user name associated with an IP address and a domain that are included in a set of harmful e-mail information, as “name of offending user” in a corresponding set of violation information, on the basis of the sets of credit information registered in the information management DB 113 and exemplified in FIG. 3. Further, for example, the notification information processing unit 114 registers a date and time at which a set of harmful e-mail information has been received, as “date and time of notification reception” in a corresponding set of violation information.

Then, the notification information processing unit 114 notifies the transmission source of the harmful e-mail of the reception of the harmful e-mail (step S703).

It should be noted that the notification information processing unit 114 may delete a set of credit information corresponding to the set of violation information, having been transmitted in the processing in step S701 and having been received, from the information management DB 113, or may set the relevant set of credit information into a retrieval halt state during a predetermined period.

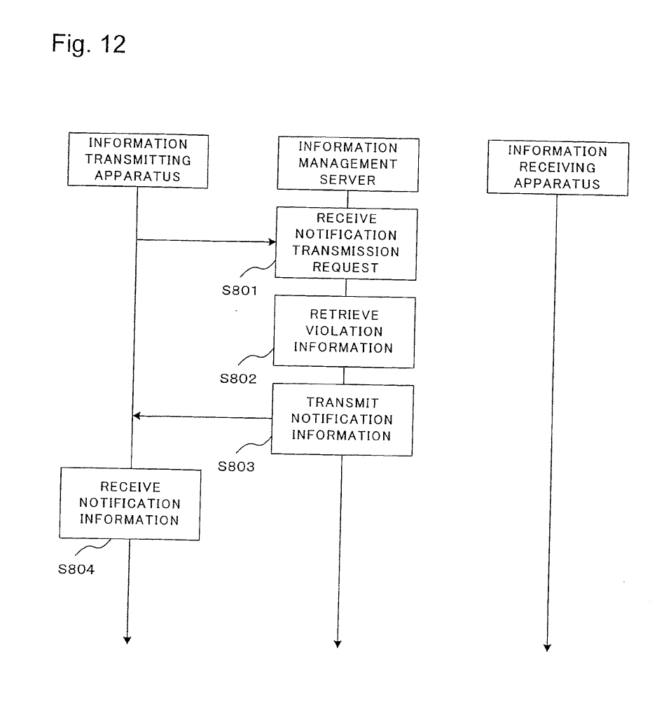

Next, the operation of the information management server 110 when the information management server provides the transmission source of a harmful e-mail with a set of notification information that is information in relation to the harmful e-mail. FIG. 12 is a sequence diagram illustrating the operation of the information management server 110 when the information management server provides a set of notification information to the information transmitting apparatus 130, which is the transmission source of a harmful e-mail. As shown in FIG. 12, the information management server 110 (specifically, the notification information processing unit 114) receives a request for transmission of a set of notification information from the information transmitting apparatus 130 (specifically, the notification information receiving unit 133) (step S801). Here, it is supposed that this request includes information indicating the information transmitting apparatus 130, which is the transmission source.

Further, the notification information processing unit 114 retrieves a set of violation information related to a harmful e-mail and to be provided to the information transmitting apparatus 130, from the information management DB 113, on the basis of the request having been received in the processing in step S801 (step S802). Specifically, the notification information processing unit 114 recognizes that information included in the request having been received in the processing in step S801 indicates the information transmitting apparatus 130, and then, retrieves, from the information management DB 113, a set of violation information in which its “offending user” is “user A”, which is the operator of the information transmitting apparatus 130, among the sets of violation information shown in FIG. 11.

The notification information processing unit 114 transmits a set of notification information including the set of violation information, having been retrieved in the processing in step S802, to the information transmitting apparatus 130 (step S803).

The set of notification information, having been transmitted in the processing in step S803, is received by the information transmitting apparatus 130 (specifically, the notification information receiving unit 133) (step S804).

According to the present exemplary embodiment, sets of credit information each associated with a corresponding one of information transmitting apparatuses 130 are registered in the information management server 110. Then, the information management server 110 delivers a set of delivery information based on the sets of credit information, to the information receiving apparatus 120. Accordingly, in accordance with the set of delivery information, based on the sets of credit information registered in the information management server 110, the information receiving apparatus 120 is able to determine whether or not an e-mail having been transmitted by the information transmitting apparatus 130 is harmful. Further, with this configuration, the information receiving apparatus 120 is able to perform handling in an appropriate manner upon reception of a harmful e-mail. Specifically, for example, e-mails each having high reliability (i.e., e-mails each having a high harmlessness degree) are delivered to client terminals coupled to the information receiving apparatus 120. Further, e-mails each having high reliability (i.e., e-mails each having a high harmlessness degree) are delivered to client terminals coupled to the information receiving apparatus 120 by allowing the information receiving apparatus 120 to indicate a determination result indicating whether or not each of delivered e-mails is harmful to each of the client terminals. This configuration, therefore, enables users of the client terminals to read the e-mails with security.

It is to be noted that, in this embodiment, a case in e-mails are transmitted from the information transmitting apparatus 130 to the information receiving apparatus 120 has been described, but without limited to such a case, electronic data having a different form may be transmitted from the information transmitting apparatus 130 to the information receiving apparatus 120.

### Second Exemplary Embodiment

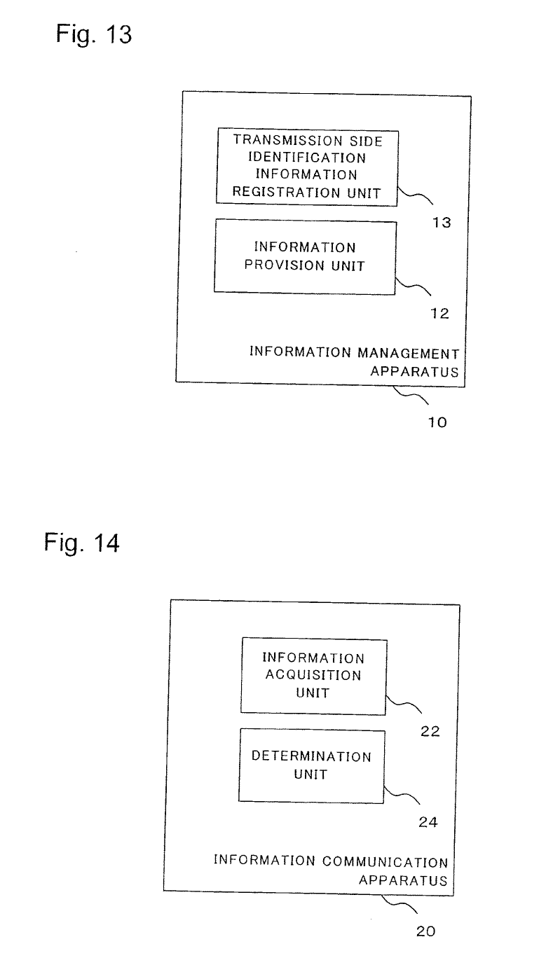

Next, an information management apparatus 10 according to a second exemplary embodiment of the present invention, will be described with reference to the drawings. FIG. 13 is a block diagram illustrating an exemplary configuration of the information management apparatus 10 according to the second exemplary embodiment of the present invention. As shown in FIG. 13, the information management apparatus 10 according to the second exemplary embodiment of the present invention, includes a transmission side identification information registration unit 13 and a information provision unit 12.

The transmission side identification information registration unit 13 corresponds to, for example, the information management DB 113 in the first exemplary embodiment of the present invention shown in FIG. 1. Further, the information provision unit 12 corresponds to, for example, the information delivery processing unit 112 in the first exemplary embodiment of the present invention shown in FIG. 1.

In the transmission side identification information registration unit 13, a set of transmission-side identification information that enables identification of a transmission-side information communication apparatus disposed at a transmission side of correspondence information and corresponding to the information transmitting apparatus 130 shown in FIG. 1 is registered, provided that the transmission-side information communication apparatus satisfies a predetermined condition.

The information provision unit 12 provides the set of transmission-side identification information, registered in the transmission-side identification information registration unit 13, to a reception-side information communication apparatus disposed at a reception side of the correspondence information and corresponding to the information receiving apparatus 120 shown in FIG. 1.

Here, the set of transmission-side identification information includes an Internet identifier.

According to this exemplary embodiment, the set of transmission-side identification information, which enables identification of the transmission-side information communication apparatus that satisfies a predetermined condition, is registered in the transmission-side identification information registration unit 13. Then, the information provision unit 12 provides the set of transmission-side identification information to the reception-side information communication apparatus, disposed at the reception side of the correspondence information. This configuration, therefore, enables the information management apparatus 10 to provide the reception-side information communication apparatus, disposed at the reception side of the correspondence information, with information that enables the reception-side information communication apparatus to determine whether or not e-mails having been transmitted by the transmission-side information communication apparatus, disposed at the transmission side of the correspondence information, are harmful.

### Third Exemplary Embodiment

Next, an information management apparatus 20 according to a third exemplary embodiment of the present invention, will be described with reference to the drawings. FIG. 14 is a block diagram illustrating an exemplary configuration of the information management apparatus 20 according to the third exemplary embodiment of the present invention. As shown in FIG. 14, the information management apparatus 20 according to the third exemplary embodiment of the present invention, includes an information acquisition unit 22 and a determination unit 24.

The information acquisition unit 22 corresponds to, for example, the information acquisition unit 122, shown in FIG. 1, in the first exemplary embodiment of the present invention. Further, the determination unit 24 corresponds to, for example, the mail determination unit 124, shown in FIG. 1, in the first exemplary embodiment of the present invention.

The information acquisition unit 22 acquires at least one set of transmission-side identification information provided by an information management apparatus (corresponding to the information management server 110 shown in FIG. 1) including a transmission-side identification information registration means (corresponding to the information management DB 113 shown in FIG. 1) and an information provision means (corresponding to the information delivery processing unit 112 shown in FIG. 1). The at least one set of transmission-side identification information, provided by the information management apparatus, is included in sets of transmission-side identification information which are registered in the transmission-side identification information registration means and each of which includes an Internet identifier and enables identification of a corresponding one of transmission-side communication apparatuses (corresponding to the information transmitting apparatus 130 shown in FIG. 1) each disposed at a transmission side of correspondence information and satisfying a predetermined condition. At least one of the sets of transmission-side identification information, registered in the transmission-side identification information registration means, is provided to a reception-side communication apparatus (corresponding to the information receiving apparatus 120 shown in FIG. 1) disposed at a reception side of the correspondence information by the information provision means.

The determination unit 24 determines whether or not correspondence information is harmful, in accordance with whether or not information for identifying a transmission source of the correspondence information is included in the at least one set of transmission-side identification information, having been acquired by the information acquisition unit 22.

According to this embodiment, the information acquisition unit 22 acquires at least one set of transmission-side identification information each of which enables identification of a transmission-side information communication apparatus having satisfied a predetermined condition. Then, the determination unit 24 determines whether or not correspondence information is harmful, in accordance with whether or not information for identifying a transmission source of the correspondence information is included in the at least one set of transmission-side identification information, having been acquired by the information acquisition unit 22. This configuration, therefore, enables the information communication apparatus 20 to determine whether or not an e-mail having been transmitted by a transmission-side communication apparatus disposed at a transmission side of correspondence information is harmful.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents. Further, it is noted that the inventor's intent is to retain all equivalents of the claimed invention even if the claims are amended during prosecution.

According to the present invention, upon reception of harmful correspondence information, appropriate handling of the harmful correspondence information is provided.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

1. An information management apparatus comprising:
a transmission-side identification information registration unit in which at least one set of transmission-side identification information each including an Internet identifier and enabling identification of a corresponding one of at least one transmission-side information communication apparatus each disposed at a transmission side of correspondence information and satisfying a predetermined condition is registered; and
an information provision unit configured to provide a reception-side information communication apparatus disposed at a reception side of the correspondence information with at least one of the at least one set of transmission-side identification information, registered in the transmission-side identification information registration unit.

2. The information management apparatus according to claim 1, further comprising a transmission-side identification information deletion unit configured to, when a predetermined condition is satisfied, delete any one of the at least one set of transmission-side identification information, registered in the transmission-side identification information registration unit, from the transmission-side identification information registration unit.

3. The information management apparatus according to claim 1, further comprising an inquiry unit configured to, in response to a request from the reception-side information communication apparatus, inquire of one of the at least one transmission-side information communication apparatus whether or not a set of transmission-side identification information that is included in the at least one set of transmission-side identification information registered in the transmission-side identification information registration unit and that is associated with the one of the at least one transmission-side information communication apparatus is to be provided to the reception-side information communication apparatus,
wherein, in accordance with a response to the inquiry from the inquiry unit and from the one of the at least one transmission-side information communication apparatus, the provision unit provides the reception-side information communication apparatus with the set of transmission-side identification information, which is included in the at least one set of transmission-side identification information registered in the transmission-side identification information registration unit and which is associated with the one of the at least one transmission-side information communication apparatus.

4. The information management apparatus according to claim 1, wherein the information provision unit provides the reception-side information communication apparatus with the at least one of the at least one set of transmission-side identification information, registered in the transmission-side identification information registration unit, at predetermined time intervals.

5. The information management apparatus according to claim 1, wherein the Internet identifier corresponds to at least one of a domain and an IP address.

6. A communication management system comprising:
the information management apparatus according to claim 1; and
the reception-side information communication apparatus.

7. An information communication apparatus comprising:
an information acquisition unit configured to acquire at least one set of transmission-side identification information provided by an information management apparatus including a transmission-side identification information registration unit and an information provision unit, the at least one set of transmission-side identification information being included in at least one set of transmission-side identification information which are registered in the transmission-side identification information registration unit and each of which includes an Internet identifier and enables identification of a corresponding one of at least one transmission-side communication apparatus each disposed at a transmission side of correspondence information and satisfying a predetermined condition, at least one of the at least one set of transmission-side identification information, registered in the transmission-side identification information registration unit, being provided to a reception-side communication apparatus disposed at a reception side of the correspondence information by the information provision unit; and
a determination unit configured to determine whether or not the correspondence information is harmful, in accordance with whether or not information for identifying a transmission source of the correspondence information is included in the at least one set of transmission-side identification information acquired by the information acquisition unit.

8. A communication management system comprising:
an information management apparatus comprising:
a transmission-side identification information registration unit in which at least one set of transmission-side identification information each including an Internet identifier and enabling identification of a corresponding one of at least one transmission-side information communication apparatus each disposed at a transmission side of correspondence information and satisfying a predetermined condition is registered; and
an information provision unit configured to provide a reception-side information communication apparatus disposed at a reception side of the correspondence information with at least one of the at least one set of transmission-side identification information, registered in the transmission-side identification information registration unit; and
the information communication apparatus according to claim 7.

9. The communication management system according to claim 6, further comprising the transmission-side information communication apparatus.

10. The communication management system according to claim 8, further comprising the transmission-side information communication apparatus.

11. An information management method comprising:
when a transmission-side information communication apparatus at a transmission side of correspondence information satisfies a predetermined condition, registering a set of transmission-side identification information including an Internet identifier and enabling identification of the transmission-side information communication apparatus into a storage unit; and
providing a reception-side information communication apparatus at a reception side of the correspondence information with the set of transmission-side identification information, registered in the storage unit.

12. A storage medium storing an information management program that causes a computer to execute the processing of:
a transmission-side identification information registration process of, when a transmission-side information communication apparatus at a transmission side of correspondence information satisfies a predetermined condition, registering a set of transmission-side identification information including an Internet identifier and enabling identification of the transmission-side information communication apparatus into a storage unit; and
an information provision processing of providing a reception-side information communication apparatus at a reception side of the correspondence information with the set of transmission-side identification information, registered in the storage unit.

13. An information management apparatus comprising:
a transmission-side identification information registration means in which at least one set of transmission-side identification information each including an Internet identifier and enabling identification of a corresponding one of at least one transmission-side information communication apparatus each disposed at a transmission side of correspondence information and satisfying a predetermined condition is registered; and
an information provision means configured to provide a reception-side information communication apparatus disposed at a reception side of the correspondence information with at least one of the at least one set of transmission-side identification information, registered in the transmission-side identification information registration means.

14. An information communication apparatus comprising:
an information acquisition means configured to acquire at least one set of transmission-side identification information provided by an information management apparatus including a transmission-side identification information registration means and an information provision means, the at least one set of transmission-side identification information being included in at least one set of transmission-side identification information which are registered in the transmission-side identification information registration means and each of which includes an Internet identifier and enables identification of a corresponding one of at least one transmission-side communication apparatus each disposed at a transmission side of correspondence information and satisfying a predetermined condition, at least one of the at least one set of transmission-side identification information, registered in the transmission-side identification information registration means, being provided to a reception-side communication apparatus disposed at a reception side of the correspondence information by the information provision means; and
a determination means configured to determine whether or not the correspondence information is harmful, in accordance with whether or not information for identifying a transmission source of the correspondence information is included in the at least one set of transmission-side identification information acquired by the information acquisition means.
